(19) United States
(12) Patent Application Publication
(10) Pub. No.: US 2014/0109567 A1
(43) Pub. Date: Apr. 24, 2014

(54) Hydraulic Converter and Hydraulic Brake

(71) Applicant: Gustav Magenwirth GmbH & Co., KG, Bad Urach (DE)

(72) Inventors: Joachim Hujer, Grabenstetten (DE); Jochen Coconcelli, Metzingen (DE)

(73) Assignee: Gustav Magenwirth GmbH & Co., KG, Bad Urach (DE)

(21) Appl. No.: 14/141,515

(22) Filed: Dec. 27, 2013

Related U.S. Application Data
(63) Continuation of application No. PCT/EP2012/061799, filed on Jun. 20, 2012.

(30) Foreign Application Priority Data
Jun. 27, 2011 (DE) 10 2011 078 153.6

(51) Int. Cl. B60T 11/224; B62L 3/02; B60T 7/10; B60T 11/10

(52) U.S. Cl. CPC B60T 11/224; B60T 11/10; B62L 3/023; B60T 7/10
USPC 60/594; 188/151 R; 60/445

(57) ABSTRACT

A hydraulic converter for a hydraulic brake system or clutch system, in particular, of a handlebar-steered vehicle, in particular of a bicycle, includes at least one hydraulic master device and a mechanical slave device for actuating the hydraulic master device. The hydraulic master device comprises a cylinder with a pressure chamber, a piston arranged in the cylinder displaceably along the axis of the cylinder, and the hydraulic converter having an adjustment device for adjusting the volume of the pressure chamber of the cylinder.

### CROSS-REFERENCE TO RELATED APPLICATIONS

This is a continuing application, under 35 U.S.C. §120, of copending international application No. PCT/EP2012/061799 filed on Jun. 20, 2012, which designated the United States and was not published in English; this application also claims the priority, under 35 U.S.C. §119, of German Patent Application No. 10 2011 078 153.6 filed on Jun. 27, 2011, the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present invention lies in the field of brakes. The present disclosure relates to a hydraulic converter, in particular to a hydraulic converter for a hydraulic brake system or a hydraulic clutch system of handlebar-steered vehicles, and more particularly for a bicycle hydraulic brake system and a hydraulic bicycle rim brake.

### BACKGROUND OF THE INVENTION

In the case of bicycles, there are known integrated brake actuator and gear change fittings in which the brake actuator fitting has a control cable for actuating a brake that is placed under tension to actuate the brake. Hydraulic converters, which convert the control cable tension into a hydraulic pressure, are required if a hydraulic brake, instead of a mechanical brake, is to be used in combination with the integrated brake actuator and gear change fitting.

When fitting and removing a bicycle wheel it is necessary, in the case of rim brakes, to move the tire between the brake pads of the rim brake. Because the brake pads have a relatively small clearance from the rim in operation, it would be advantageous, for quick and simple fitting and removal of the wheel, to be able to move the brake pads away from one another in a simple manner to create sufficient space for fitting and removing the wheel.

### SUMMARY OF THE INVENTION

The invention provides a hydraulic converter that overcomes the hereinafore-mentioned disadvantages of the heretofore-known devices and methods of this general type and that provide such features with a simple and easily operated pressure relief capability and in which the working point can be adjusted simply and easily.

With the foregoing and other objects in view, there is provided, in accordance with the invention, a hydraulic converter for a hydraulic system including at least one hydraulic master device comprising a cylinder defining a pressure chamber and having an axis and a piston disposed in the cylinder displaceably along the axis of the cylinder, a mechanical slave device configured to actuate the hydraulic master device, and an adjustment device configured to adjust the volume of the pressure chamber of the cylinder. The hydraulic converter is for a hydraulic brake system or clutch system, in particular, of a handlebar-steered vehicle, in particular of a bicycle.

With the objects of the invention in view, there is also provided a hydraulic converter for a hydraulic system including at least one hydraulic master device comprising a cylinder defining a pressure chamber and having an axis and a piston disposed in the cylinder displaceably along the axis of the cylinder, the housing defining a cylinder receptacle in which the cylinder is disposed displaceably, a mechanical slave device configured to actuate the hydraulic master device, an adjustment device configured to adjust the volume of the pressure chamber of the cylinder, the adjustment device having a releasable locking device between the housing and the cylinder, and a locking pin having a locking section, the housing defining a receptacle for the locking pin, the cylinder defining a receptacle shaped to receive the locking section of the locking pin.

With the objects of the invention in view, there is also provided a hydraulic converter for a hydraulic system including at least one hydraulic master device comprising a cylinder defining a pressure chamber and having an axis and a piston disposed in the cylinder displaceably along the axis of the cylinder, a mechanical slave device configured to actuate the hydraulic master device, and an adjustment device configured to adjust the volume of the pressure chamber of the cylinder and configured and disposed to adjustably alter a distance between the at least one hydraulic master device and the mechanical slave device.

With the objects of the invention in view, there is also provided a hydraulic brake comprising the hydraulic converter.

With the objects of the invention in view, there is also provided a rim brake comprising the hydraulic converter.

In accordance with another feature of the invention, there is provided a housing in which the cylinder is disposed displaceably, the adjustment device including a releasable locking device between the housing and the cylinder.

In accordance with a further feature of the invention, the housing defines a cylinder receptacle in which the cylinder is disposed displaceably.

In accordance with an added feature of the invention, there is provided a locking pin having a locking section, the housing defining a receptacle for the locking pin, the cylinder defining a receptacle shaped to receive the locking section of the locking pin.

In accordance with an additional feature of the invention, the at least one hydraulic master device is at least two hydraulic master devices and the mechanical slave device is at least two mechanical slave devices.

In accordance with yet another feature of the invention, the at least two mechanical slave devices each have a respective lever member, the lever members each being connected by a bearing bush, a hollow pin, or both the bearing bush and the hollow pin.

In accordance with yet a further feature of the invention, the locking pin has a locking position, and further comprising a spring configured and disposed to preload the locking pin to the locking position and to captively connect the locking pin on the housing.

In accordance with yet an added feature of the invention, there is provided a tensioning pin rigidly connected to the housing, the spring having a receiving portion through which passes the tensioning pin.

In accordance with yet an additional feature of the invention, the adjustment device is configured and disposed to adjustably alter a distance between the at least one hydraulic master device and the mechanical slave device.

In accordance with again another feature of the invention, the mechanical slave device is pivoted to the housing about a pivot axis and the adjustment device is configured and disposed to adjustably alter a position of the pivot axis.

In accordance with again a further feature of the invention, the hydraulic system is a hydraulic brake system or a hydraulic clutch system.

In accordance with again an added feature of the invention, the hydraulic system is a hydraulic system of a handlebar-steered vehicle.

In accordance with a concomitant feature of the invention, the hydraulic system is a hydraulic system of a bicycle.

According to a configuration of the invention, there is specified a hydraulic converter for a hydraulic brake system or clutch system, in particular of a handlebar-steered vehicle, in particular of a bicycle, comprising at least one hydraulic master device and a mechanical slave device for actuating the hydraulic master device, the hydraulic master device comprising a cylinder with a pressure chamber, a piston being arranged in the cylinder displaceably along the axis of the cylinder, and the hydraulic converter having an adjustment device for adjusting the volume of the pressure chamber of the cylinder.

The adjustment device enables the volume of the pressure chamber to be adjusted and, specifically, to be adjusted independently of actuation of the mechanical slave device.

For example, the pressure chamber may be greatly enlarged to displace a hydraulic rim brake actuated with the hydraulic master device to a position in which the wheels can be fitted and removed easily. Through the enlargement of the pressure chamber, the hydraulic medium is drawn from the slave cylinders of the hydraulic rim brake into the hydraulic master device. The pistons in the slave device are retracted thereby and the brake pads are, therefore, moved far from the rim to ensure easy and simple fitting or removal of the wheel.

The adjustment of the volume of the pressure chamber may also serve to adjust the working point of the hydraulic system, that is, for example, the pressure point at which a brake or clutch responds when actuated.

According to the invention, the hydraulic converter may have a housing in which the cylinder is disposed displaceably, the adjustment device including a releasable locking device between the housing and the cylinder.

According to the invention, the housing may have a cylinder receptacle in which the cylinder is disposed displaceably.

According to the invention, the housing may have a receptacle for a locking pin that includes a locking section, and the cylinder may have a receptacle for receiving the locking section of the locking pin.

According to the invention, the hydraulic converter may have at least two hydraulic master devices and at least two mechanical slave devices.

According to the invention, the at least two mechanical slave devices may each comprise a lever member, which lever members are connected by a bearing bush and/or a hollow pin.

According to the invention, the bearing bush and/or the hollow pin may connect the two lever members captively to one another. Assembly is thereby considerably simplified because both lever members no longer have to be aligned with respect to the bearing pin, the bearing pin needing only, for example, to be pushed through its receptacle in the housing and through the common hollow pin or the common bearing bush and to be fitted into the other receptacle on the other side of the housing.

According to the invention, the material of the lever members and of the bearing bush or hollow pin may be selected such that the material pairing makes possible a bearing arrangement without the provision of further bearing measures. For example, the parts may be made from suitable plastics materials known to the person skilled in the art.

According to the invention the bearing bush and/or the hollow pin may be mounted on one bearing pin. Alternatively, the two lever members may be mounted separately.

According to the invention, there may be provided a spring, which is configured and disposed such that it preloads the locking pin to its locking position and disposes it captively on the housing. To perform this double function, the spring may have a bracing section or a pretensioning section or an engagement section that engages, for example, in a receptacle provided in the locking pin.

Advantageously, one spring is provided for both hydraulic master devices. In addition to the advantage of providing fewer parts with less weight, this configuration has the advantage that the spring can less easily become twisted during assembly.

According to the invention, the spring may have a receptacle section through which passes a tensioning pin connected rigidly to the housing. This configuration has the advantage of providing security against unintended removal of the tensioning pin securing the spring because the tensioning pin can be removed only with a special tool. Because the spring, in turn, secures the two locking pins to the housing, accidental loss of the locking pins can be prevented. The locking pins are important for ensuring that the hydraulic converter can be operated in its working position.

According to an alternative configuration of the invention, the hydraulic converter might be preloaded to the working position without the locking pins and be tensioned only by engagement of the locking pin in a position in which the volume of the hydraulic master device(s) is increased in order to make possible, for example, the fitting and removal of a wheel.

According to the invention, the adjustment device may be configured and disposed such that the distance between the hydraulic master device and the mechanical slave device is adjustable.

According to the invention, the mechanical slave device may be pivoted to the housing about a pivot axis, and the adjustment device may be configured and disposed such that the position of the pivot axis is adjustable.

According to the invention, the material of the housing of the hydraulic converter may be diecast and/or may comprise fiber-reinforced plastics material, in particular, carbon fiber reinforced and/or glass fiber reinforced plastics material, for example, a duroplast and/or a thermoplastic.

According to the invention, adjustment of the working point may be provided. For this purpose one or more adjusting wheels projecting from the housing may be provided. For example, the working points of both hydraulic master devices may be adjusted with one adjusting wheel. To achieve equal adjustment of the working point, the mechanism of the mechanical slave devices may include oppositely pitched threads. For example, the working points of the two hydraulic master devices and/or tool-less brake pad adjusters of the two hydraulic slave devices (for example, rim brakes or disc brakes or clutches) may be adjusted separately from one another using a plurality of adjusting wheels.

According to the invention, a hydraulic brake, in particular, a hydraulic rim brake having a hydraulic converter according to the invention, is also specified.

Thus, a need exists to overcome the problems with the prior art systems, designs, and processes as discussed above.

Although the invention is illustrated and described herein as embodied in a hydraulic converter and hydraulic brake, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a fragmentary, cross-sectional view of a hydraulic converter along section line I-I of FIG. 3 according to an exemplary embodiment of the invention in a pressure-relieved position;

FIG. 2 is a fragmentary, cross-sectional view of the hydraulic converter of FIG. 1 with the converter in a working position;

FIG. 3 is a top plan view (in relation to the vehicle) of the hydraulic converter of FIG. 1;

FIG. 4 is a bottom plan view (in relation to the vehicle) of the hydraulic converter of FIG. 1;

FIG. 5 is a fragmentary, rear elevational view (in relation to the vehicle) of the hydraulic converter of FIG. 1;

FIG. 6 a fragmentary, front elevational view (in relation to the vehicle) of the hydraulic converter of FIG. 1;

FIG. 7 is a fragmentary, cross-sectional view of the hydraulic converter of FIG. 1 along section line VII-VII of FIG. 1;

FIG. 8 is an exploded perspective view of the hydraulic converter of FIG. 1;

FIG. 9 is a fragmentary, schematic side elevational view of a hydraulic converter according to an exemplary embodiment of the invention integrated in a handlebar forward extension bracket;

FIG. 10A is a schematic bottom plan view (in relation to the vehicle) of a cylinder for a hydraulic converter according to an exemplary embodiment of the invention;

FIG. 10B is a schematic bottom plan view (in relation to the vehicle) of a cylinder for a hydraulic converter according to an exemplary embodiment of the invention;

FIG. 11 is a schematic top plan view (in relation to the vehicle) of a hydraulic converter according to an exemplary embodiment of the invention;

FIG. 12 is a cross-sectional view corresponding to FIG. 7 of a hydraulic converter according to a further exemplary embodiment of the invention;

FIG. 13 is a front elevational view (in relation to the vehicle) of a schematic representation of an adjustment device of the hydraulic converter of FIG. 12;

FIG. 14 is a cross-sectional view corresponding to FIG. 7 of a hydraulic converter according to a further exemplary embodiment of the invention; and

FIG. 15 is a front elevational view (in relation to the vehicle) of a schematic representation of the adjustment device of the hydraulic converter of FIG. 14.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

In the description of the exemplary embodiment the following reference numerals are used:
100 Hydraulic converter
101 Connecting piece
102 Hydraulic line
103 Hydraulic master device
104 Mechanical slave device
105 Adjustment device
106 Signal device
107 Cylinder receptacle
108 Adjusting wheel
109 Adjusting wheel
110 Housing
111 Housing body
112 Housing cover
113 Receptacle (for forward extension bracket fastening member 114)
114 Forward extension bracket fastening member
115 Screw
116 Adjustment opening
117 Receptacle (for locking pin 140)
118 Connector (e.g. for control cable)
119 Receptacle (for securing pin 159 for spring 150)
120 Cylinder
121 Pressure chamber
122 Cylinder wall
123 Receptacle (for connecting piece 101)
124 Receptacle (for locking pin 140)
124A Series of holes (for locking pin 140)
124B Locking receptacle (for locking pin 140)
125 Hydraulic passage
126 Filling nozzle
127 Closing element
128 Stop
130 Piston
131 Spring
132 Spring receptacle
133 Collar
134 Seal
135 Collar
136 Plunger receptacle
140 Locking pin
141 Actuating head
142 Locking section
143 Spring receptacle
150 Spring
151 Tensioning portion
152 Receiving portion
153 Support portion
159 Securing pin
160 Plunger
161 Head section
162 Central section
163 Threaded section
164 Engagement section
170A Lever member
171A Bearing receptacle
172A Plunger engagement member receptacle
173A Control cable engagement member receptacle
170B Lever member
171B Bearing receptacle
172B Plunger engagement member receptacle
173B Control cable engagement member receptacle
174 Latching lip
180 Hollow pin or bearing bush
181 Bearing pin
182 Bearing pin receptacle
182A Slot (for adjustably receiving the bearing pin)
183 Plunger engagement member
184 Control cable engagement member
185 Grub screw
190 Handlebar forward extension bracket
191 Handlebar stem
192 Forward extension
193 Screws
194 Receptacle for handlebar tube

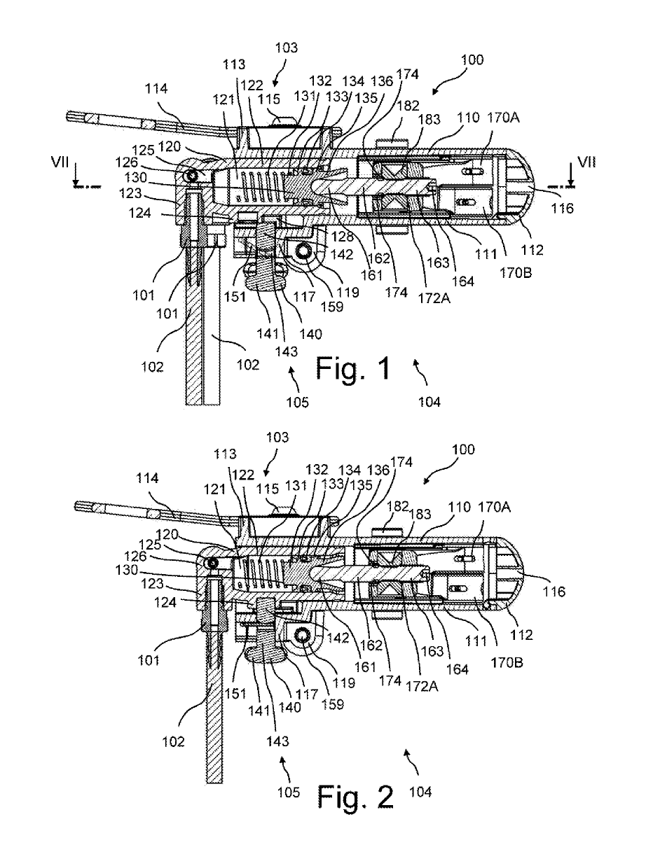

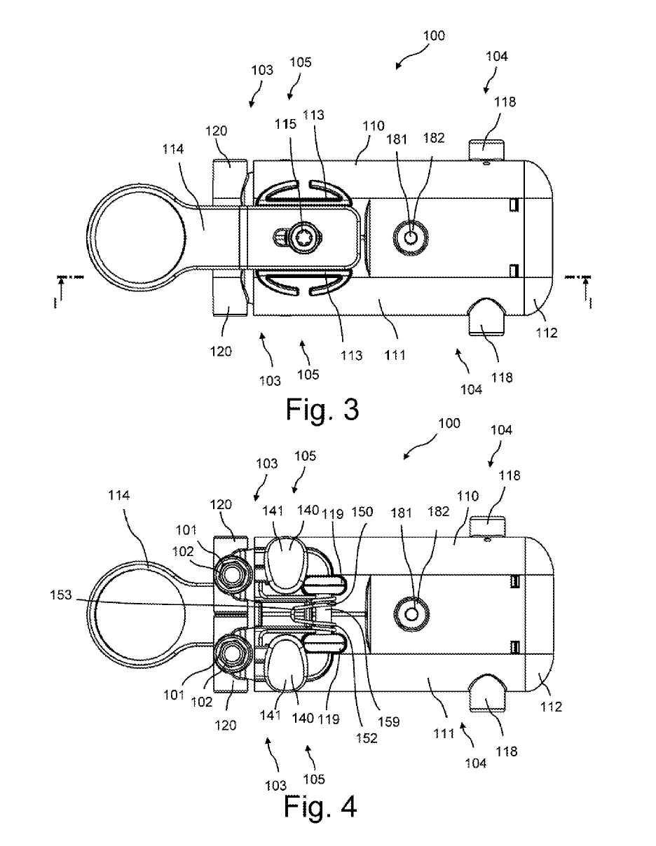

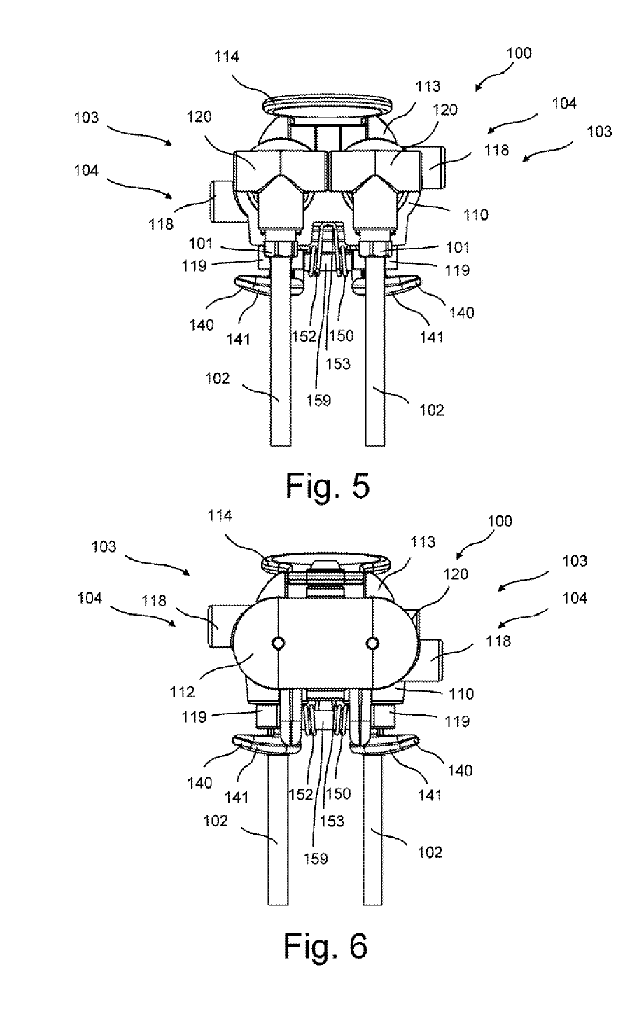

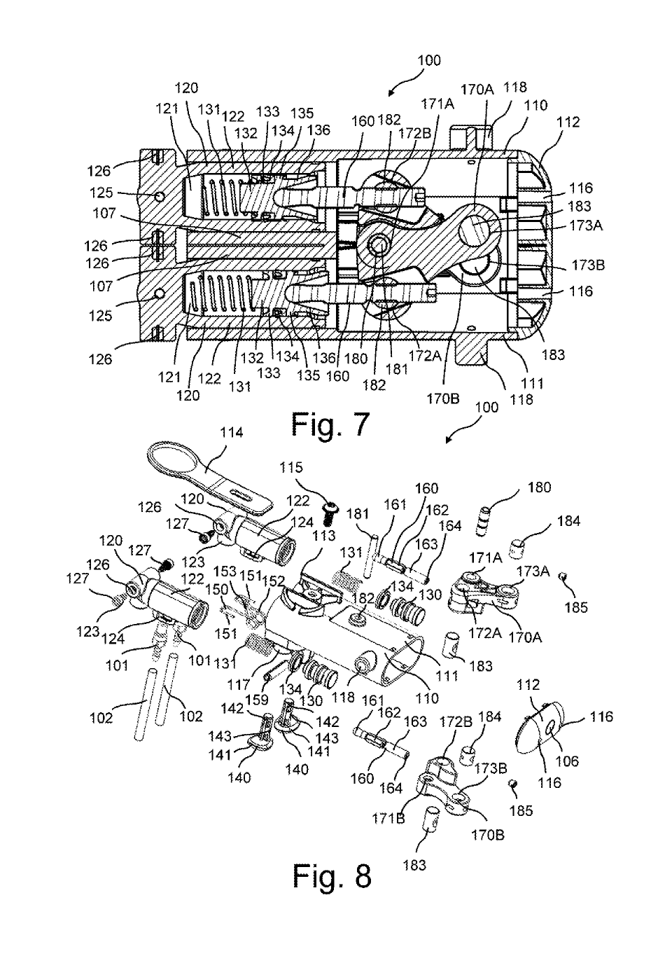

Described now are exemplary embodiments of the present invention. Referring now to the figures of the drawings in detail and first, particularly to FIGS. 1 to 8, there is shown a first exemplary embodiment of a hydraulic converter according to an exemplary embodiment of the invention.

The hydraulic converter 100 comprises two mechanical slave devices 104 and two hydraulic master devices 103. The two mechanical slave devices 104 are coupled to two mechanical master devices (not shown), for example, through control cables that, in a fashion known to the person skilled in the art, are tensioned through, for example, brake levers of a bicycle upon actuation of the brakes and actuate the mechanical slave devices 104. In the hydraulic converter 100, the mechanical actuation of the mechanical slave devices 104 is converted into an actuation of the hydraulic master devices 103. These are connected in a manner known to the person skilled in the art to hydraulic brakes (not shown), for example, a front wheel brake and a rear wheel brake.

The hydraulic converter 100 has two hydraulic master devices 103 comprising a cylinder 120 in each case.

The cylinders 120 have a pressure chamber 121 and a cylinder wall 122. The cylinder 120 has a receptacle 123 in which a connecting piece 101 is received in a manner known to the person skilled in the art, by which connecting piece 101 a hydraulic line 102 is connected to the cylinder 120. The pressure chamber 121 is connected to the hydraulic line 102 through a hydraulic passage 125.

The cylinder 120 has, on both sides of its head, filling nozzles 126, which in each case are closed with a closing element 127. The filling nozzle 126 is in each case provided with a Luer cone so that the hydraulic system can be filled using a commercially available syringe. Because the filling nozzles 126 are provided on both sides, both cylinders 120 can be configured completely identically, representing a considerable saving in production cost due to the fact that one less injection molding needs to be produced. A cup may be provided in each filling nozzle 126 so that filling must take place through a so-called swan neck formed by the filling nozzle and the syringe tip in order to make possible bubble-free filling of the hydraulic system. The cup may be, for example, a widening of the filling nozzle 126 provided at the end of the cone, a connecting line to the hydraulic system being provided at the edge of the filling nozzle 126.

A piston 130 that, upon actuation of the corresponding mechanical master device (not shown), is urged in the direction of the pressure chamber 121 and is disposed in the cylinder 120 displaceably along the cylinder axis. The hydraulic medium in the pressure chamber 121 is thereby pressurized, whereby a hydraulic slave device (for example, a brake or a clutch) is actuated in a manner known to the person skilled in the art.

The piston 130 has a spring receptacle 132 on which is received a spring 131 that projects into the pressure chamber 121 disposed ahead of the piston 130. In the inactive state, the piston 130 is pretensioned against the force of the spring 131. Upon actuation of the hydraulic master device 103, the piston 130 is urged against the force of the spring 131 in the direction of the pressure chamber 121 and, if applicable, is displaced. After the actuation of the hydraulic master device 103 has ended, the piston 130 is pushed back, if applicable, to its inactive position by the force of the spring 131.

The piston 130 has a collar 133 and a collar 135 between which is provided a seal 134 in known fashion, with which seal 134 the piston 130 is sealed with respect to the cylinder wall 122. On a side opposite the spring receptacle 132, the piston 130 has a plunger receptacle 136 for receiving a plunger 160 by which the piston 130 is coupled to the mechanical slave device 104.

The plungers 160 have a head section 161 that engages in the plunger receptacle 136 of the piston 130. The central section 162 of the plunger 160 is provided with an external profile that cooperates with latching lips 174 provided in the mechanical slave devices 104. As a result of the pressure exerted by the latching lips 174 on the external profile of the central section 162, unintended displacement of the plunger 160, and therefore of the working point of the hydraulic system, are avoided. Moreover, precise stepwise adjustment is possible, because the operator receives an indication by “clicks” when the external profile of the central section 162 moves over the latching lip 174, which strikes against the external profile of the central section 162 and generates a tone at each transition of the external profile. The operator can, therefore, count such indications to receive a measure for the adjustment and, for example, can perform a corresponding or different adjustment for the two brake circuits.

The plungers 160 further have a threaded section 163 for engaging with the mechanical slave device 104, and an engagement section 164 for adjusting the working point through rotation of the threaded section 163 in the receptacle of the mechanical slave device 104 and, therefore, for adjusting the inactive position of the piston 130 in the cylinder 120. Two adjustment openings 116 through which the operator can engage with the respective engagement section 164 by a tool (for example an Imbus key) are provided in a housing 110.

If required, a compensation reservoir for hydraulic fluid may be provided in a manner known to the person skilled in the art, which compensation reservoir is connected through a compensation bore in a manner known to the person skilled in the art to the interior of the cylinder 120, over which compensation bore the piston 130 passes upon being actuated. Compensation reservoirs are provided with hydraulic disc brakes and/or clutch systems, for example. In the case of hydraulic rim brakes, it is not essential to provide a compensation reservoir.

The hydraulic converter 100 comprises the housing 110 with a housing body 111 and a cover 112 mounted thereon. The housing body 111 and the housing cover 112 form a substantially complete encasement of the parts of the hydraulic converter 100. This has the advantage that the parts are better protected against dirt and external influences. The housing 110 may be equipped with receptacles (not shown in detail) for fastening, for example, mobile telephones, navigation systems, bicycle computers, tachometers, GPS systems, lighting systems, etc.

The housing has a receptacle 113 in which a forward extension bracket fastening member 114 is received and secured with a screw 115. The forward extension bracket fastening member 114 has a fastening portion with which the hydraulic converter 100 can be fastened to a handlebar stem of a bicycle. The size of the opening in the fastening portion corresponds to the opening of distance pieces (spacers) that are provided in a manner known to the person skilled in the art on the handlebar stem below a nut with which the handlebar is secured to the bicycle. To secure the hydraulic converter 100, the forward extension bracket fastening member 114 may be provided instead of a distance piece (spacer) such that the hydraulic converter 100 projects forwardly from the handlebar stem below the handlebar forward extension bracket. Because of the rotatable receptacle, angular adaptation to the forward extension bracket is readily possible. Alternatively, a projection may be provided in the forward extension bracket fastening member 114, which ensures a certain orientation, for example, corresponding to that of the forward extension bracket.

The two mechanical slave devices 104 are actuated by mechanical master devices (not shown) through control cables (not shown). Connections 118 disposed at different levels are provided on both sides in the housing 110 of the hydraulic converter 100. The two mechanical slave devices 104 have respective lever members 170A, 170B, which are mounted rotatably in the housing 110 via a common bearing pin 181 in bearing pin receptacles 182. The lever members 170A, 170B have respective bearing receptacles 171A, 171B in which is disposed a hollow pin 180 connecting the two lever members 170A, 170B to one another. The bearing pin 181 on which the two lever members 170A, 170B are jointly mounted is disposed in the hollow pin 180. This configuration with one hollow pin for connecting the two lever members 170A, 170B has the advantage that, during assembly, both lever members 170A, 170B can be disposed and installed jointly in the housing 110, without the need to align the two bearing receptacles 171A, 171B with one another in order to install the bearing pin 181.

The two lever members 170A, 170B further have respective plunger engagement member receptacles 172A, 172B, in each of which is provided a respective plunger engagement member 183, into which the threaded section 163 of the respective plunger 160 engages.

The two lever members 170A, 170B further have respective control cable engagement member receptacles 173A, 173B, in each of which a control cable engagement member 184, in which the respective control cable is secured by a grub screw 185, is provided.

On the plunger engagement member receptacles 172A, 172B the two lever members 170A, 170B each have a respective latching lip 174 that is in engagement with the external contour of the central section 162 of the corresponding plunger 160 in order to make possible defined and controlled adjustment of the working point, and securing of the set working point, as described in detail above.

The hydraulic converter 100 has two adjustment devices 105 that are independent of, or uncoupled from, one another. In the exemplary embodiment of the invention represented in FIGS. 1 to 8, the two cylinders 120 are each disposed displaceably in the housing 110 such that the distance between the cylinder 120 and the respective mechanical slave device 104 is adjustable. For this purpose, the housing 110 has two cylinder receptacles 107 in which the cylinders 120 are disposed displaceably.

If the cylinder 120 is moved away from the mechanical slave device 104 without the mechanical slave device 104 being actuated, the volume of the pressure chamber 121 is increased, whereby hydraulic medium is drawn in from the hydraulic slave element 103 into the hydraulic master element. In the case of an hydraulic rim brake, the brake pads are, therefore, retracted from their rest position to a position in which the wheel can be easily fitted and removed (quick release).

In the working position, the respective cylinder 120 is secured to the housing 110 by a respective locking pin 140. The locking pin 140 has an actuating head 141 and a locking section 142 with which the locking pin 140 engages in a receptacle 124 of the corresponding cylinder 120. The housing 110 has two receptacles 117 in which the two locking pins 140 are disposed.

In its locking position, the respective locking pin 140 engages with its locking section 142 in the receptacle 124 of the corresponding cylinder 120 and secures the cylinder 120 against displacement in the housing 110. If the locking pin 140 is withdrawn from the receptacle 124, the cylinder 120 is moved away from the plunger 160 by the force of the spring 131, so that the piston 130 is withdrawn from the cylinder 120, or the cylinder 120 is displaced with respect to the piston 130, such that the volume of the pressure chamber 121 is increased. The increase in the volume of the pressure chamber 121 is limited by the volume of the hydraulic medium that can be drawn from the hydraulic slave element. For this reason, a mechanical stop 128 that limits the displacement of the cylinder 120 in the housing 110 may optionally be additionally or alternatively provided. However, this stop 124 need not necessarily be present. As soon as the possible volume of hydraulic medium has been drawn from the hydraulic slave element 103, for example, in the case of a hydraulic rim brake, the brake pads are in a fully retracted position, which permits simple fitting or removal of a wheel.

A spring 150 is provided to preload the locking pins 140 to a respective locking position. The spring 150 has two tensioning portions 151 that engage in respective spring receptacles 143 of the locking pins 140. The spring 150 has a bow-shaped support portion 153 with which the spring 150 bears against the housing 110. The spring 150 further has a receiving portion 152 formed by two short spiral-shaped portions extending on both sides of the support portion 153. The spring 150 is secured to the housing 110 with a securing pin 159, which extends through receptacles 119 provided on the housing 110 and through the receiving portion 152, or through the two spiral-shaped portions of the spring 150.

Upon retraction of the locking pins 140 from the locking position to the release position, the corresponding tensioning portion 151 is tilted downwards (in relation to the vehicle), while the corresponding spiral portion of the receiving portion 152 of the spring 150 is twisted, or the spring 150 is deformed; that is, the locking pin 140 is loaded to its locking position. Nevertheless, because the cylinder 120 is displaced from the housing 110 rearwardly (in relation to the vehicle), the locking pin 140 cannot engage in the receptacle 124. In order to engage the locking pin 140 in the receptacle again, the user must press on the cylinder 120 from the front and push it back into the housing 110. As soon as the cylinder 120 is again in its working position, the receptacle 124 is again located below the locking pin 140, so that it can again engage with its locking section 142 in the receptacle 124.

The spring 150, therefore, has multiple functions. It serves to retain the two locking pins 140 captively because the tensioning portions 151 engage in a receptacle 143 of the respective locking pin 140. In addition, the spring 150 has the function of preloading the locking pins 140 to the locking position. It is advantageous that one spring 150 is provided for both hydraulic master devices 103. In addition to saving parts, this configuration has the advantage during installation that the spring 150 can be more easily aligned because it is prevented from becoming twisted during assembly by the engagement of the two tensioning portions 151.

A signal device 106, for example an LED lamp which can serve for illumination while riding and/or as a warning light, may be provided on the cover 112 of the housing 110. Alternatively or additionally, flashing lights or other signal devices may be provided.

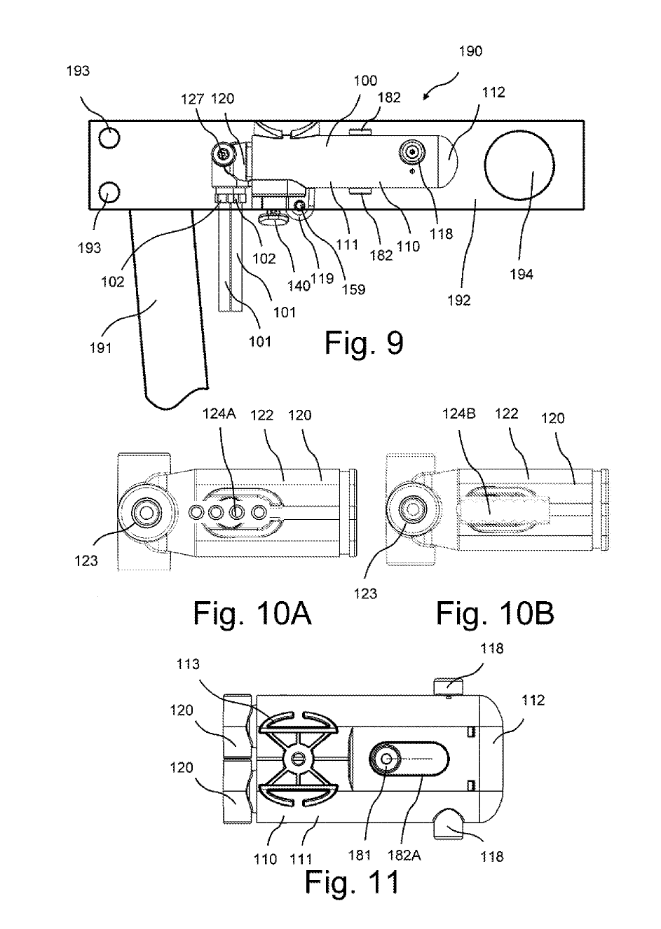

FIG. 9 shows an alternative exemplary embodiment of a hydraulic converter 100 according to the invention. Like parts are provided with the same reference numerals. In the following exposition, only the differences from the other exemplary embodiments are described, reference being otherwise made to the description thereof, in particular to the description of the embodiment of the invention represented in FIGS. 1 to 8.

The hydraulic converter 100 shown in FIG. 9 is integrated directly in a handlebar forward extension bracket 190. The handlebar forward extension bracket 190 has a handlebar stem 191 and a forward extension 192, which is fastened to the handlebar stem in known fashion with screws 193 and has a receptacle 194 for a handlebar tube (not shown). It is clear that, in this exemplary embodiment of the invention, the housing 110 can also be omitted and the corresponding features of the housing 110 can be integrated in the forward extension 192; that is, the forward extension 192 forms the housing for the hydraulic converter 100. A further weight reduction can be achieved thereby.

FIGS. 10A and 10B show alternative cylinders 120 for a hydraulic converter 100 as shown in FIGS. 1 to 8. The cylinders 100 differ from one another and from the embodiment shown in FIGS. 1 to 8 by the different configuration of the receptacle 124 for the locking pin 140. For this reason, only the differences from the other exemplary embodiments will be described below, reference being otherwise made to the description thereof, in particular to the description of the embodiment of the invention represented in FIGS. 1 to 8. It is clear that adaptations of the other parts, and in particular of the housing, to the changed receptacle 124 of the cylinder 120, must be carried out.

In the exemplary embodiment shown in FIG. 10A, a series of holes 124A with four receptacles for the locking pin 140 is provided. The cylinder 100 can, thereby, be locked in different positions in which the volume of the pressure chamber is different, so that different working points can be set, or a position can be reached in which, for example, the pads of a hydraulic rim brake are fully retracted to make possible easy fitting or removal of a wheel.

In the exemplary embodiment shown in FIG. 10B, a locking receptacle 124B is provided that permits locking of the locking pin in multiple positions. In the embodiment shown, the locking receptacle 124B has a shape that can be achieved, for example, by a plurality of circles disposed side-by-side and that resembles, for example, the external shape of the middle part of a caterpillar. Other forms are self-evidently possible. With the locking receptacle 124B, finer adjustment of the working point can be achieved. Moreover, if it is used, for example, with a hydraulic rim brake, a position for easy fitting and removal of a wheel can be set.

FIG. 11 shows an alternative exemplary embodiment of a hydraulic converter 100 according to the invention. Like parts are provided with the same reference numerals. In the following exposition only the differences from the other exemplary embodiments are described, reference being otherwise made to the description thereof, in particular to the description of the embodiment of the invention represented in FIGS. 1 to 8.

In the hydraulic converter 100 shown in FIG. 11, the bearing pin 181 for the two mechanical slave devices 104, instead of the cylinder, is disposed displaceably in the housing. In the position shown, the bearing pin 181 is in the position that is closest to the cylinders of the hydraulic master devices 103, that is, in a working position in which the volume in the pressure chambers has a particular value. A slot 182A for adjustably receiving the bearing pin 181 is provided in the housing 110. The distance between the mechanical slave devices 104 and the hydraulic master devices 103 can, therefore, be increased to enlarge the volume of the pressure chambers and, therefore, to place the hydraulic converter 100 in a pressure-relieved position in which, for example, the brake pads of a hydraulic rim brake are in the fully retracted position.

In this exemplary embodiment, the volumes of the two pressure chambers of the two hydraulic circuits (for example, for front wheel brake and rear wheel brake) can be adjusted or changed only jointly, because the two mechanical slave devices have a common pivot point or bearing pin 181.

According to exemplary embodiments of the invention not illustrated, separate pivot points or bearing pins for the individual mechanical slave devices may also be provided. This also applies to the other exemplary embodiments of the invention, in particular to the exemplary embodiment represented in FIGS. 1 to 8. However, the provision of separate bearing pins is especially advantageous for the exemplary embodiments in which adjustment of the volume of the pressure chamber is effected by displacing the bearing pin because, in that case, the two circuits can be adjusted separately. In some applications, however, it is desirable if adjustment takes place jointly.

It is evident that embodiments are also to be provided according to the invention in which both the hydraulic master device and the mechanical slave device can be configured to be displaceable or adjustable with respect to the common housing. If only one bearing pin is provided in that case, this has the advantage that a joint adjustment can be made by adjusting the position of the bearing pin, and a separate adjustment can be made by separate adjustment of the cylinders, for example.

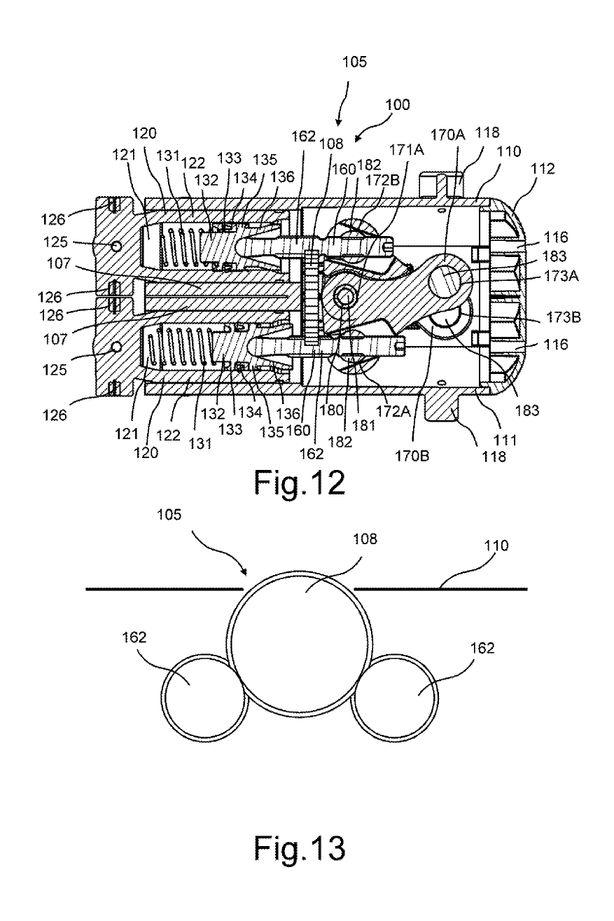

FIGS. 12 and 13 show an alternative exemplary embodiment of a hydraulic converter 100 according to the invention. Like parts are denoted by the same reference numerals. In the following exposition, only the differences from the other exemplary embodiments will be described and reference is otherwise made to the description thereof, in particular to the description of the embodiment of the invention represented in FIGS. 1 to 8. In the exemplary embodiment represented in FIGS. 12 and 13, an adjusting wheel 108 is provided with an external toothing (not shown) that meshes with external toothings (not shown) provided on the respective central sections 162 of the plungers 160. To achieve joint adjustment of the respective working points by rotating the adjusting wheel 108, that is, to achieve a joint adjustment in the same direction, the threaded sections 163 of the two plungers 160 and the corresponding plunger receiving members 183 must be configured with oppositely pitched threads, that is, for example, with right-hand and left-hand threads.

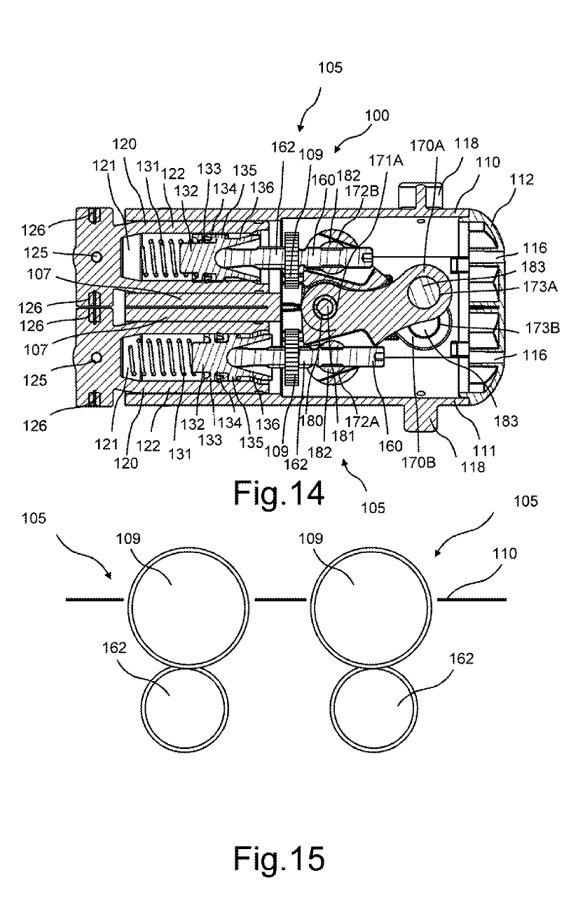

FIGS. 14 and 15 show an alternative exemplary embodiment of a hydraulic converter 100 according to the invention. Like parts are denoted by the same reference numerals. In the following exposition only the differences from the other exemplary embodiments will be described and reference is otherwise made to the description thereof, in particular to the description of the embodiments of the invention represented in FIGS. 1 to 8, and 12 and 13.

In the exemplary embodiment represented in FIGS. 14 and 15, two adjusting wheels 109 are provided, which have external toothings meshing (not shown) with external toothings (not shown) provided on the respective central sections 162 of the plungers 160. With this embodiment, the two working points can be adjusted independently of one another.

According to the invention, the mechanical slave devices may also be actuated directly with a brake lever, as is usual with hydraulic brake fittings. In these exemplary embodiments of the invention, only one hydraulic master device and one mechanical slave device is preferably provided in each case. For each brake circuit (front, rear) one hydraulic converter and one actuator fitting may then be provided in each case.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A hydraulic converter for a hydraulic system, comprising:
at least one hydraulic master device comprising a cylinder defining a pressure chamber and having:
an axis; and
a piston disposed in the cylinder displaceably along the axis of the cylinder;
a mechanical slave device configured to actuate the hydraulic master device; and
an adjustment device configured to adjust a volume of the pressure chamber of the cylinder.

2. The hydraulic converter according to claim 1, further comprising a housing in which the cylinder is disposed displaceably, the adjustment device including a releasable locking device between the housing and the cylinder.

3. The hydraulic converter according to claim 2, wherein the housing defines a cylinder receptacle in which the cylinder is disposed displaceably.

4. The hydraulic converter according to claim 2, further comprising a locking pin having a locking section, the housing defining a receptacle for the locking pin, the cylinder defining a receptacle shaped to receive the locking section of the locking pin.

5. The hydraulic converter according to claim 1, wherein:
the at least one hydraulic master device is at least two hydraulic master devices; and
the mechanical slave device is at least two mechanical slave devices.

6. The hydraulic converter according to claim 5, wherein the at least two mechanical slave devices each have a respective lever member, the lever members each being connected by a bearing bush, a hollow pin, or both the bearing bush and the hollow pin.

7. The hydraulic converter according to claim 4, wherein the locking pin has a locking position, and further comprising a spring configured and disposed to preload the locking pin to the locking position and to captively connect the locking pin on the housing.

8. The hydraulic converter according to claim 7, further comprising a tensioning pin rigidly connected to the housing, the spring having a receiving portion through which passes the tensioning pin.

9. The hydraulic converter according to claim 1, wherein the adjustment device is configured and disposed to adjustably alter a distance between the at least one hydraulic master device and the mechanical slave device.

10. The hydraulic converter according to claim 2, wherein:
the mechanical slave device is pivoted to the housing about a pivot axis; and
the adjustment device is configured and disposed to adjustably alter a position of the pivot axis.

11. The hydraulic converter according to claim 1, wherein the hydraulic system is a hydraulic brake system or a hydraulic clutch system.

12. The hydraulic converter according to claim 1, wherein the hydraulic system is a hydraulic system of a handlebar-steered vehicle.

13. The hydraulic converter according to claim 1, wherein the hydraulic system is a hydraulic system of a bicycle.

14. A hydraulic brake, comprising the hydraulic converter according to claim 1.

15. A rim brake, comprising the hydraulic converter according to claim 1.

16. A hydraulic converter for a hydraulic system, comprising:
at least one hydraulic master device comprising a cylinder defining a pressure chamber and having:
an axis; and
a piston disposed in the cylinder displaceably along the axis of the cylinder;
a housing defining a cylinder receptacle in which the cylinder is disposed displaceably;
a mechanical slave device configured to actuate the hydraulic master device;
an adjustment device configured to adjust a volume of the pressure chamber of the cylinder, the adjustment device having a releasable locking device between the housing and the cylinder; and
a locking pin having a locking section, the housing defining a receptacle for the locking pin, the cylinder defining a receptacle shaped to receive the locking section of the locking pin.

17. A hydraulic converter for a hydraulic system, comprising:
at least one hydraulic master device comprising a cylinder defining a pressure chamber and having:
an axis; and
a piston disposed in the cylinder displaceably along the axis of the cylinder;
a mechanical slave device configured to actuate the hydraulic master device; and
an adjustment device:
configured to adjust a volume of the pressure chamber of the cylinder; and
configured and disposed to adjustably alter a distance between the at least one hydraulic master device and the mechanical slave device.

18. The hydraulic converter according to claim 17, further comprising a housing in which the cylinder is disposed displaceably, the adjustment device including a releasable locking device between the housing and the cylinder, the mechanical slave device being pivoted to the housing about a pivot axis, the adjustment device being configured and disposed to adjustably alter a position of the pivot axis.
